(19) United States
(12) Patent Application Publication
(10) Pub. No.: US 2010/0239088 A1
(43) Pub. Date: Sep. 23, 2010

(54) METHOD AND SYSTEM FOR DIGITAL CONTENT PROTECTION

(75) Inventor: Mario Torbarac, New South Wales (AU)

Correspondence Address: WOOD, PHILLIPS, KATZ, CLARK & MORTIMER, 500 W. MADISON STREET, SUITE 3800, CHICAGO, IL, 60661, US

(73) Assignee: DTR LIMITED, Hong Kong (CN)

(21) Appl. No.: 12/225,058

(22) PCT Filed: Mar. 12, 2007
(86) PCT No.: PCT/AU2007/000306

§ 371 Date: Jun. 8, 2010

Related U.S. Application Data
(60) Provisional application No. 60/781,631, filed on Mar. 13, 2006.

(51) Int. Cl. H04N 7/167; H03M 13/05; G06F 11/08; G06F 21/24

(52) U.S. Cl. 380/201; 380/210; 714/752; 726/30; 713/189; 714/E11.03

(57) ABSTRACT

Methods, systems and computer program products for copy protecting content data to be stored on storage media are disclosed. At least one location in the content data is selected for insertion of a predetermined data sequence, which, upon re-trieval from the storage media by a data retrieval apparatus, is capable of rendering the data retrieval apparatus incapable of correctly retrieving the content data from the storage media. The predetermined data sequence is inserted at the at least one selected location in the content data and the content data and predetermined data sequence are processed such that the data retrieval apparatus is capable of correctly retrieving the content data from original storage media the content data is stored on and is incapable of correctly retrieving the content data from a copy of the original storage media.

### RELATED APPLICATIONS

The present application claims priority from U.S. patent application no. 60/781,631, filed on 13 Mar. 2006. The entire contents of U.S. patent application No. 60/781,631 are incorporated herein by way of reference.

### FIELD OF THE INVENTION

The present invention relates generally to protection of digital content and more particularly to copy protection of digital content stored on optical media such as digital video disk or digital versatile disk (DVD).

### BACKGROUND

Playback of content stored on an optical disc involves optically reading pits and lands on the disc using a laser, which entails following a spiral track on the disc and providing the pit-to-land and land-to-pit transitions as a high frequency (HF) signal to a decoder. The decoder demodulates the HF signal from eight-to-sixteen modulation (EFM+) into a bit stream that is subsequently de-interleaved, error corrected (PI/PO) and de-scrambled. Scrambling is employed to minimize excessive high frequencies (HF) and occurrences of high Digital Sum Value (DSV) or DC content accumulation. Thereafter, the data is subjected to error detection code (EDC) checking. On a video disc, once the bit stream is correctly decoded and it has been ascertained that there are no errors, CSS decryption is performed using valid authentication and cryptographic keys. Finally, the bit stream is passed to various decode buffers in the video player for processing and/or output of the video, audio and control data streams.

The Content Scrambling System (CSS) is a method for protecting DVD-Video content via content encryption and authentication. Descrambling requires a pair of cryptographic keys. One key is unique to the disc, while the other key is unique to the content (e.g., MPEG-2) file being descrambled. The keys are stored in hidden areas of the disc, which can only read by compliant disc drives. Anyone wishing to build compliant disc drives is required to obtain a license, which dictates that the full copy-protection system be implemented. However, the CSS has been cryptographically compromised and is easily and routinely circumvented.

Accordingly, a need exists for improved methods and systems for protecting content stored on storage media such as DVD video discs.

### SUMMARY

Aspects of the present invention relate to methods, systems and computer program products for copy protecting content data to be stored on storage media.

A first aspect of the present invention provides a method for copy protecting content data to be stored on storage media. At least one location in the content data is selected for insertion of a predetermined data sequence, which upon retrieval from the storage media by a data retrieval apparatus, is capable of rendering the data retrieval apparatus incapable of correctly retrieving the content data from the storage media. The predetermined data sequence is inserted at the at least one selected location in the content data and the content data and predetermined data sequence are processed such that the data retrieval apparatus is capable of correctly retrieving the content data from original storage media the content data is stored on and is incapable of correctly retrieving the content data from a copy of the original storage media.

Another aspect of the present invention provides a method for copy protecting encrypted content data to be stored on a DVD. The method comprises the steps of selecting a target sector in the encrypted content data, decrypting the target sector, determining a Logical Block Address for the selected target sector, scrambling the target sector using an Initialization Vector derived from the Logical Block Address, selecting at least one location in the scrambled target sector for inserting a predetermined data sequence, inserting the predetermined data sequence into the at least one location, scrambling the target sector and encrypting the target sector.

Another aspect of the present invention provides a method for copy protecting content data to be stored on a DVD. The method comprises the steps of inserting a predetermined data sequence into at least one location in a selected target sector in the content data, generating error control coding information for an error control coding block the target sector is part of, and providing the error control coding information and the target sector content data without the predetermined data sequence inserted for storage on the DVD. The error control coding information is generated based on the content data with the predetermined data sequence inserted,

A further aspect of the present invention provides a computer system for copy protecting content data to be stored on storage media. The computer system comprises a memory unit for storing data and instructions to be performed by a processing unit and a processing unit coupled to the memory unit. The processing unit is programmed to select at least one location in the content data for insertion of a predetermined data sequence which upon retrieval from the storage media by a data retrieval apparatus is capable of rendering the data retrieval apparatus incapable of correctly retrieving the is content data from the storage media, insert the predetermined data sequence at the at least one selected location in the content data, and process the content data and the predetermined data sequence such that the data retrieval apparatus is capable of correctly retrieving the content data from original storage media the content data is stored on and is incapable of correctly retrieving the content data from a copy of the original storage media.

Another aspect of the present invention provides a computer system for copy protecting content data to be stored on a DVD. The computer system comprises a memory unit for storing data and instructions to be performed by a processing unit and a processing unit coupled to the memory unit. The processing unit is programmed to select a target sector in the encoded content data, decrypt the target sector, determine a Logical Block Address for the selected target sector, descramble the target sector using an Initialization Vector derived from the Logical Block Address, select one or more locations in the descrambled target sector for inserting a predetermined data sequence, insert the predetermined data sequence into the one or more locations, scramble the target sector and encrypt the target sector.

A further aspect of the present invention provides a computer system for copy protecting content data to be stored on a DVD. The computer system comprises a memory unit for storing data and instructions to be performed by a processing unit and a processing unit coupled to the memory unit. The processing unit is programmed to insert a predetermined data sequence into at least one location in a selected target sector in the content data, generate error control coding information for an error control coding block the target sector is part of, and provide the error control coding information and the target sector content data without the predetermined data sequence inserted for storage on the DVD. The error control coding information is generated based on the content data with the predetermined data sequence inserted.

Still another aspect of the present invention provides a computer program product comprising a computer readable medium comprising a computer program recorded therein for copy protecting content data to be stored on storage media. The computer program product comprises computer program code means for selecting at least one location in the content data for insertion of a predetermined data sequence which upon retrieval from the storage media by a data retrieval apparatus is capable of rendering the data retrieval apparatus incapable of correctly retrieving the content data from the storage media, computer program code means for inserting the predetermined data sequence at the at least one selected location in the content data, and computer program code means for processing the content data and the predetermined data sequence such that the data retrieval apparatus is capable of correctly retrieving the content data from original storage media the content data is stored on and is incapable of correctly retrieving the content data from a copy of the original storage media.

Yet another aspect of the present invention provides a computer program product comprising a computer readable medium comprising a computer program recorded therein for copy protecting encrypted content data to be stored on a DVD. The computer program product comprises computer program code means for selecting a target sector in the encrypted content data, computer program code means for decrypting the target sector, computer program code means for determining a Logical Block Address for the selected target sector, computer program code means for scrambling the target sector using an Initialization Vector derived based on the Logical Block Address, computer program code means for selecting at least one location in the content data for insertion of a predetermined data sequence which is capable of rendering a data retrieval apparatus incapable of correctly retrieving the content data from the DVD, computer program code means for inserting the predetermined data sequence into the at least one location, computer program code means for scrambling the target sector, and computer program code means for encrypting the target sector.

Still another aspect of the present invention provides a computer program product comprising a computer readable medium comprising a computer program recorded therein for copy protecting encrypted content data to be stored on a DVD. The computer program product comprises computer program code means for inserting a predetermined data sequence into at least one location in a selected target sector in the content data, computer program code means for generating error control coding information for an error control coding block the target sector is part of, and computer program code means for providing the error control coding information and the target sector content data without the predetermined data sequence inserted for storage on the DVD. The error control coding information is generated based on the content data with the predetermined data sequence inserted.

Yet another aspect of the present invention provides an apparatus comprising a processing unit for executing a computer software application for transcoding digital content into a format suitable for storing on conventional DVD recordable media, a network interface coupled to the processing unit for receiving said digital content via a communications network, and an optical disk writer coupled to the processing unit for transferring the transcoded digital content to conventional DVD recordable media. The digital content received via the network interface is copy protected in accordance with one or more methods for copy protection of digital content described herein.

### BRIEF DESCRIPTION OF THE DRAWINGS

A small number of embodiments are described hereinafter, by way of example only, with reference to the accompanying drawings in which:

FIG. 1 is a flow diagram of a conventional method for encoding a DVD;

FIG. 2 is a flow diagram of a method for copy protecting content to be stored on storage media;

FIG. 3 is a flow diagram of a method for inserting a predetermined data sequence into content data prior to encoding of the content data for creation of a DVD according to an embodiment of the present invention;

FIG. 4 is a flow diagram of a method for inserting a predetermined data sequence into content data prior to encoding of the content data for creation of a DVD according to another embodiment of the present invention;

FIG. 5 (comprising FIGS. 5A, 5B and 5C) is a flow diagram of a method for inserting a predetermined data sequence into. content data during encoding of the content data for creation of a DVD according to another embodiment of the present invention; and

FIG. 6 is a schematic block diagram of a computer system with which embodiments of the present invention may be practised.

### DETAILED DESCRIPTION

Embodiments of methods and systems are described hereinafter for protecting content stored on optical media such as a DVD from certain types of copying or piracy.

Certain of the embodiments described hereinafter are described with specific reference to the DVD-ROM disc. However, it is not intended that the present invention be limited in this manner as the principles of the present invention have general applicability to other types of digital storage media and/or formats. Some examples of disc formats with which embodiments of the present invention may be practised include, but are not limited to: Compact Disc (CD), UMD (Universal Media Disc), HD-DVD (High Definition DVD) and BD-ROM (BluRay).

Certain of the embodiments described hereinafter are described with specific reference to the CSS encryption system. However, the present invention may alternatively be practised in conjunction with other types of encryption systems, with the obvious alterations taken into consideration for the differences in the encoding and error correction mechanisms of the alternate standards. Method for Encoding DVDs

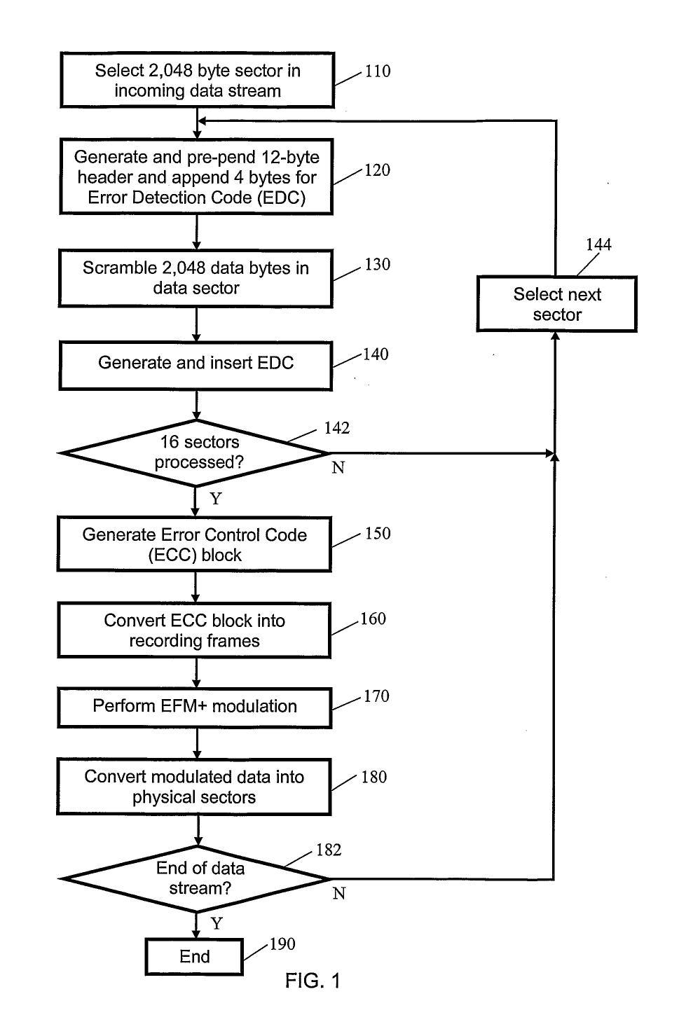

FIG. 1 is a flow diagram of a conventional method for encoding a DVD. The specification relating to this method has been published by the European Computer Manufacturers Association (ECMA) as Standard ECMA-267, 3^{rd} edition, April 2001. The reader is referred to the ECMA-267 specification, which is incorporated herein by reference in its entirety, for more detailed information relating to the method of FIG. 1. The ECMA-267 specification is available online at the URL: http://www.ecma-international.org/publications/files/ECMA-ST/Ecma-267.pdf.

The incoming content data stream is formatted into 2,048-byte sectors and processed in accordance with the ECMA-267 Standard. The content data is processed in blocks of 16 sectors at a time as Error Control Code (ECC) Blocks and recording frames generated each comprise 16 sectors.

Referring to FIG. 1, a 2,048 byte sector is selected from the incoming data stream for processing at step 110.

At step 120, a 12-byte header is generated and pre-pended and four bytes for Error Detection Code (EDC) check bytes are appended to the selected data sector to form a 2064-byte data frame. The header comprises an ID field (4 bytes), an IED field that comprises an error detection code covering the ID (2 bytes), and a RESERVED field that contains Copyright Management Information (6 bytes). The RESERVED field is referred to as the CPR_MAI field in certain specifications such as ECMA-267.

At step 130, the 2,048 data bytes in the selected data sector are scrambled, with the scrambler codec Initialization Vector (IV) preset to a specified value, which is seeded by bits 7-4 of the selected sector's ID. Accordingly, the ECC block that contains the selected sector determines the scrambler codec's IV. The scrambler is defined on page 25 of the ECMA-267 specification and comprises a feedback shift register.

At step 140, the Error Detection Code (EDC) is generated and inserted into the 4 bytes allocated in step 120.

At step 142, a determination is made whether 16 sectors have been processed as this would be indicative of a ECC block boundary. If not (N), the next sector is selected at step 144 and processing reverts to step 120. If 16 sectors have been processed (Y), at step 142, processing continues at step 150.

At step 150, an Error Control Code (ECC) block is generated, as per the ECMA-267 specification, being an array having 192 rows of 172 bytes. 16 bytes of Parity Outer (PO) code words are appended to each of the 172 columns and 10 bytes of Parity Inner (PI) code words are appended to each of the resulting 208 rows. A complete ECC block thus comprises 208 rows of 182 bytes per row, which gives a total of 37,856 bytes per ECC block.

At step 160, the ECC block is converted into recording frames by interleaving one of the 16 PO rows after each 12 rows of an ECC block. This is performed by is relocation of the bytes as defined in the ECMA-267 standard. At completion of step 160, there exist 16 recording frames, each comprising 2,366 bytes in an array of 13 rows of 182 bytes from the respective previously generated ECC block.

At step 170, the 8-bit bytes of each recording frame are transformed into 16-bit code words using Eight-to-Sixteen Modulation (EFM+) for writing to the optical media. EFM+ modulation is defined in the ECMA-267 specification and comprises a conversion process that uses specified tables and rules.

At step 180, the EFM+ modulated data generated in step 170 is converted into physical sectors for transferring to the optical media. This includes the insertion of two synchronization (SYNC) words at the start of each 1,456 bits (91 bytes).

At step 182, a determination is made the end of the incoming data stream has been reached. If not (N), the next sector is selected at step 144 and processing reverts to step 120. If there is no more data to be processed (N), the method ends at step 190.

### EFM+ Modulation

The ECMA-267 specification dictates that the 8-bit bytes of each Recording Frame are transformed into 16-bit Code Words with the run length limitation that between 2 ONEs there shall be at least 2 ZEROs and at most 10 ZEROs (RLL 2, 10). Annex G of the ECMA-267 specification provides conversion tables to be applied in the modulation process to guarantee the foregoing run length limitation. The Main Conversion table and the Substitution table specify a 16-bit Code Word for each 8-bit byte with one of 4 states. For each 8-bit byte, the tables indicate the corresponding Code Word, as well as the State for the next 8-bit byte to be encoded.

### Digital Sum Value (DSV) Accumulation

Digital Sum Value (DSV) accumulation or DC content (bias) accumulation results from an unequal number of low states compared to high states (pit to land transitions and visa versa) read during playback of a DVD. Excessive DSV accumulation typically results in similar effects to those caused by scratches and other imperfections on the data read-back side of a DVD. For example, even moderate amounts of DSV accumulation slows down the data retrieval or playback process. More excessive levels of DSV accumulation result in unreliable tracking of the pits and lands and decoding of the pit and land lengths, which may result in a complete loss of signal in an area on the DVD. It should be noted that DSV is an artifact of the DVD modulation process and that a certain level of DSV is thus always present. However, ECMA-267 and other specifications go to significant length to minimize the amount of DSV present on DVD media. According to the ECMA-267 specification, “During the DSV computation, the actual values of the DSV may vary between −1000 and +1000, thus it is recommended that the count range for the DSV be at least from −1 024 to +1 023”. DSV values greater than 1,024 are thus likely to result in unreliable tracking.

### High Frequency (HF) Noise

HF noise results from a high rate of pit-to-land and land-to-pit transitions during data retrieval or playback. It should be noted that HF is a totally different phenomenon to DSV accumulation, but the resulting effect during data retrieval or playback from pirate DVD copies is the same. In fact, the effective DC content or bias is typically zero or close to zero as a result of HF noise. HF noise is an artifact of the DVD encoding process and a certain level of HF noise is thus always present. However, ECMA-267 and other specifications go to significant length to minimize the amount of HF noise generated during data retrieval or playback from DVD media. Excessive levels of HF noise result in unreliable tracking of the pits and lands and decoding of the pit and land lengths, which may result in a complete loss of signal in an area on the DVD.

### Content Protection Using Predetermined Data Sequence/s

In embodiments of the present invention, one or more predetermined data sequence/s is/are inserted into the original content data prior to, during, or subsequent to encoding of the content data for creation of a DVD, in a controlled fashion. Such predetermined data sequence/s may include DSV accumulation and/or HF noise generating data sequences. However, other types of predetermined data sequences may be used alternatively or in addition to DSV accumulation and/or HF generating data sequences in other embodiments of the present invention. For example, Content Controlled Cumulative Pit Overexposure (C3PO) data sequences may be inserted into the original content data prior to, during, or subsequent to encoding of the content data for creation of a DVD, in a controlled fashion. The additional predetermined data sequence/s is/are processed (i.e., the actual data values are changed) such that the effects of such additional data during data retrieval or playback of content from legitimate, originally encoded DVDs is not manifested. However, the effects of the additional data are manifested during retrieval or playback of copied or pirated DVDs.

In DVD applications, it is important that the additionally introduced predetermined data sequences comprise legitimate Code Words from the Main Conversion Table in the ECMA-267 Specification. The present inventor has identified a number of Code Words in the Main Conversion Table that, when optically read repeatedly, are capable of generating a sufficient level of DSV accumulation or HF during data retrieval or playback such that playback failure will occur (e.g., a loss of tracking). The data bytes or sequences (prior to EFM+ modulation during encoding of a DVD) that correspond to these Code Words include:
0x95
0x5 cc5 (or 0xc55c)
0x8995 (or 0x9589)
0x8e9e (or 0x9e8e)
0x959e (or 0x9e95)

The present inventor has also identified a particularly suitable Code Word in the Main Conversion Table that, when optically read repeatedly, is capable of generating a sufficient level of HF noise during data retrieval or playback such that tracking will be lost. The 8-bit byte (prior to EFM+ modulation during encoding of a DVD) that corresponds to this Code Word is:
0x62

The Code Word corresponding to the 8-bit byte 0x62 comprises an odd number of transitions. Repeating this Code Word causes a high rate of pit-to-land and land-to-pit transitions with a minimum pit length of 3T. Every second repeated byte negates any DSV accumulation from the first, so that the effective DC content or bias is zero.

The above examples are described in further detail, hereinafter.

### Example 1

### 0x95 (149₁₀)

Table 1, hereinafter, shows the results (i.e., Code Words) of looking up the 8-bit byte 0x95 in the Main Conversion table:

TABLE 1

| | State 1 | | State 2 | | State 3 | | State 4 | |
|---|---|---|---|---|---|---|---|---|
| | Code Word | | Code Word | | Code Word | | Code Word | |
| 149 | 0000100100010000 | 3 | 0000100100010000 | 3 | 1000000000100000 | 3 | 1000000000100000 | 3 |

Referring to Table 1, four 16-bit Code Words (corresponding to four different states), each followed by a next state, are provided. Significantly, the next state is always 3, irrespective of the present state, and the 8-bit byte 0x95 thus reselects state 3 repeatedly.

The state 3 Code Word is 1000000000100000, which comprises a pit length of 10 bits followed by a land length of 5 bits (a binary 1 in the Code Word is indicative of a change of state, whereas a binary 0 is indicative of a state being maintained), may be represented as [t10, t5+]. The addition sign (+) after the t5 refers to the first bit if the next Code Word, which is a binary 1. The total cumulative DSV for two successive 0x95 8-bit bytes is:

$$\begin{matrix}t 10 , t 6 , t 10 , t 6 = + 20 , - 12 \\ = + 8\end{matrix}$$

This single byte represents a high value of DSV accumulation relative to that produced by other allowable modulation sequences specified in the Main Conversion table. Coupled to the fact that the 8-bit byte 0x95 always reselects state 3, the 8-bit byte 0x95 represents an ideal single byte case for generating DSV accumulation.

### Example 2

### 0xc5 (197₁₀) and 0x5c (92₁₀)

Table 2, hereinafter, shows the results (i.e., Code Words) of looking up the 8-bit bytes 0xc5 and 0x5c in the Main Conversion table:

TABLE 2

| | State 1 | | State 2 | | State 3 | | State 4 | |
|---|---|---|---|---|---|---|---|---|
| | Code Word | | Code Word | | Code Word | | Code Word | |
| 197 | 0010001000000100 | 2 | 0010001000000100 | 2 | 1000001000000100 | 2 | 1000001000000100 | 2 |
| 92 | 0010000100001000 | 3 | 0100000000010001 | 1 | 0010000100001000 | 3 | 0100000000010001 | 1 |

Referring to Table 2, four 16-bit Code Words (corresponding to four different states), each followed by a next state, are provided. Significantly, the next state after state 1 of the 8-bit byte 0xc5 is 2 and the next state after state 2 for the 8-bit byte 0x5c is state 1. Thus, the sequence of 8-bit bytes 0xc5 and 0x5c reselects states 2 and 1 repeatedly.

The state 1 Code Word for the 8-bit byte 0xc5 is 0010001000000100 [t3+, t4, t7, t2+] and the state 2 Code Word for the 8-bit byte 0x5c is 0100000000010001 [t2+, t10, t4]. The total cumulative DSV for the sequence of 8-bit bytes 0xc55c or 0x5 cc5 is:

$$\begin{matrix}t 3 , t 4 , t 7 , t 4 , t 10 , t 4 = + 20 , - 12 \\ = + 8\end{matrix}$$

This two byte sequence provides a high value of DSV accumulation relative to that produced by the other allowable modulation sequences specified in the Main Conversion Table.

### Example 3

### 0x89 (137₁₀) and 0x95 (149₁₀)

Table 3, hereinafter, shows the results (i.e., Code Words) of looking up the 8-bit bytes 0x89 and 0x95 in the Main Conversion table:

TABLE 3

| | State 1 | | State 2 | | State 3 | | State 4 | |
|---|---|---|---|---|---|---|---|---|
| | Code Word | | Code Word | | Code Word | | Code Word | |
| 137 | 0000100001000100 | 2 | 0000100001000100 | 2 | 1000001001000100 | 3 | 1000001001000100 | 3 |
| 149 | 0000100100010000 | 3 | 0000100100010000 | 3 | 1000000000100000 | 3 | 1000000000100000 | 3 |

to Referring to Table 3, four 16-bit Code Words (corresponding to four different states), each followed by a next state, are provided. Significantly, the next state after state 3 for the 8-bit byte 0x89 is state 3 and the next state after state 3 of the 8-bit byte 0x95 is also state 3. Thus the sequence of 8-bit bytes 0x89 and 0x95 reselects state 3 repeatedly.

The state 3 Code Word for the 8-bit byte 0x89 is 1000001001000100 [t6, t3, t4, t2+] and the state 3 Code Word for the 8-bit byte 0x95 is 1000000000100000 [t10, t5+]. The total cumulative DSV for the sequence of 8-bit bytes 0x8995 or 0x9589 is:

$$\begin{matrix}t 6 , t 3 , t 4 , t 2 + , t 10 , t 6 = + 20 , - 12 \\ = + 8\end{matrix}$$

This two byte sequence provides a high value of DSV accumulation relative to that produced by the other allowable modulation sequences specified in the Main Conversion Table.

### Example 4

### 0x8e (142₁₀) and 0x9e (158₁₀)

Table 4, hereinafter, shows the results (i.e., Code Words) of looking up the 8-bit bytes 0x8e and 0x9e in the Main Conversion table:

TABLE 4

| | State 1 | | State 2 | | State 3 | | State 4 | |
|---|---|---|---|---|---|---|---|---|
| | Code Word | | Code Word | | Code Word | | Code Word | |
| 142 | 0000010000000100 | 3 | 0000010000000100 | 3 | 1000000100100100 | 3 | 1000000100100100 | 3 |
| 158 | 0010001001000100 | 3 | 0010001001000100 | 3 | 1000100100000100 | 3 | 0100100100000000 | 3 |

Referring to Table 4, four 16-bit Code Words (corresponding to four different states), each followed by a next state, are provided. Significantly, the next state after state 3 for the 8-bit byte 0x8e is state 3 and the next state after state 3 of the 8-bit byte 0x9e is also state 3. Thus the sequence of 8-bit bytes 0x8e and 0x9e reselects state 3 repeatedly.

The state 3 Code Word for the 8-bit byte 0x8e is 1000000100100100 [t7, t3, t3, t2+] and the state 3 Code Word for the 8-bit byte 0x9e is 1000100100000100 [t4, t3, t6, t2+]. The total cumulative DSV for the sequence of 8-bit bytes 0x8e9e or 0x9e8e is:

$$\begin{matrix}t 7 , t 3 , t 3 , t 3 , t 4 , t 3 , t 6 , t 3 = + 20 , - 12 \\ = + 8\end{matrix}$$

This two byte sequence provides a high value of DSV accumulation relative to is that produced by the other allowable modulation sequences specified in the Main Conversion Table.

### Example 5

### 0x95 (149₁₀) and 0x9e (158₁₀)

Table 5, hereinafter, shows the results (i.e., Code Words) of looking up the 8-bit bytes 0x95 and 0x9e in the Main Conversion table:

TABLE 5

| | State 1 | | State 2 | | State 3 | | State 4 | |
|---|---|---|---|---|---|---|---|---|
| | Code Word | | Code Word | | Code Word | | Code Word | |
| 149 | 0000100100010000 | 3 | 0000100100010000 | 3 | 1000000000100000 | 3 | 1000000000100000 | 3 |
| 158 | 0010001001000100 | 3 | 0010001001000100 | 3 | 1000100100000100 | 3 | 0100100100000000 | 3 |

Referring to Table 5, four 16-bit Code Words (corresponding to four different states), each followed by a next state, are provided. Significantly, the next state after state 3 for the 8-bit byte 0x95 is state 3 and the next state after state 3 of the 8-bit byte 0x9e is also state 3. Thus the sequence of 8-bit bytes 0x95 and 0x9e reselects state 3 repeatedly.

The state 3 Code Word for the 8-bit byte 0x95 is 1000000000100000 [t10, t5+] and the state 3 Code Word for the 8-bit byte 0x9e is 1000100100000100 [t4, t3, t6, t2+]. The total cumulative DSV for the sequence of 8-bit bytes 0x959e or 0x9e95 is:

$$\begin{matrix}t 10 , t 6 , t 4 , t 3 , t 6 , t 3 = + 20 , - 12 \\ = + 8\end{matrix}$$

This two byte sequence provides a high value of DSV accumulation relative to that produced by the other allowable modulation sequences specified in the Main Conversion Table.

### Example 6

### 0x62 (98₁₀)

Table 6, hereinafter, shows the results (i.e., Code Words) of looking up the 8-bit byte 0x62 in the Main Conversion table:

TABLE 6

| | State 1 | | State 2 | | State 3 | | State 4 | |
|---|---|---|---|---|---|---|---|---|
| | Code Word | | Code Word | | Code Word | | Code Word | |
| 98 | 0010010010010010 | 1 | 0000100100010000 | 1 | 1001001000000100 | 2 | 1001001000000100 | 2 |

Referring to Table 6, four 16-bit Code Words (corresponding to four different states), each followed by a next state, are provided. In this case, it is required to ensure that the next state selected is always 1. Accordingly, it must be ensured to start after a SYNC marker (i.e., to ensure selection of state 1 or column 1) or that the data stream in the case of a state 3 or 4 Code Word be prefixed with a value that will always yield a next selection of a state 1 or state 2 Code Word. An example is the 8-bit value of 95₁₀ or 0x5f, with which all next states would be state 1.

The state 1 Code Word for the 8-bit byte 0x62 is 0010010010010010 [t3, t3, t3, t3, t3, t1+]. The total cumulative DSV for two successive 0x62 8-bit bytes is thus:

$$\begin{matrix}t 3 , t 3 , t 3 , t 3 , t 3 , ( t 1 + t 3 = t 4 ) , t 3 , t 3 , t 3 , t 3 , ( t 1 ) = + 16 + , - 16 \\ = + 0\end{matrix}$$

This byte provides a high value of HF noise relative to that produced by the other allowable modulation sequences specified in the Main Conversion Table.

Content Protection based on Content Controlled Cumulative Pit Overexposure (C3PO)

In other embodiments, the predefined data sequences are selected to result in accumulated localized heating of the disc structure during the recoding process. The accumulated localized heating causes incorrect marks/spaces to be recorded onto the disc due to overexposure of the underlying dye.

In the normal course, the laser beam in an optical disc writer is pulsed at varying intensities and/or duty cycles to generate the required encoded marks/spaces that constitute the encoded content. For the case of a DVD, these encodings are in EFM+ (Eight to Sixteen Modulation) and are usually referred to as pits and lands in the case of pressed media and as marks and spaces in the case of recordable media. The minimum mark or space length on a DVD is T3, which represents an effect that is 3 time intervals in duration. The maximum mark or space length on a DVD (due to RLL constraints imposed by the EFM+ standard) is generally T11. However, T14 is a notable exception as it is only used to denote the presence of a synchronization symbol (SYNC).

C3PO is based upon predefined data streams which, when encoded, will yield a valid EFM+ data stream comprising repeated marks of long duration separated by spaces of short duration. An optimal situation would be a T11 mark followed by T3 space in a repeated fashion. This high ratio of ON periods to OFF periods results in an accumulation of localized heating at the disc substrate and will, in very short order, create over exposure of the marks at the expense of the spaces. The resulting effect is that the T11 length marks drift in length due to the exposure at a rate roughly in proportion to the duration of the sequence. It has been observed that, after some repetition and consequent accumulated local heating, the intended T11's are elongated to become closer to T12's (which are outside the requirements of the ECMA-267 specification). This is at the expense of the following T3's, which become closer to T2's (which are, again, outside the requirements of the ECMA-267 specification). The resulting effect is that of instability and erroneous decoding of the encoded stream.

A glass master disk used in the production of pressed media is relatively more resilient to accumulated local heating than recordable media. Accordingly, a glass master is able to withstand a longer duration of the above described predefined data streams without exhibiting the effects that result on recordable media. C3PO thus has potential for use in anti-piracy, hard-to-replicate, signature and/or watermarking systems.

C3PO may also be used to affect data written to the disk track in close proximity to the overexposed regions. For example, if an overexposing sequence is written to the disk, apart from causing the pit to extend in length (such as a T11 becoming a T12), the width of the pit can also be overexposed to cause the pit to overlap its track spiral boundary and thus affect the two tracks located radially on either side of the track having the overexposed pit. The resulting effect is a loss of focus and/or tracking during playback.

Again, it is important that the overexposing data sequence comprise legitimate Code Words from the Main Conversion Table in the ECMA-267 Specification for the case of DVDs. The present inventor has identified such a Code Word that contains T11s followed by T3s. The 8-bit byte sequence (prior to EFM+ modulation during is encoding of a DVD) that corresponds to this Code Word is 0xabcf (i.e., 0xab followed by 0xcf, and repeated as necessary).

### Example: 0xab (171₁₀) and 0xcf (207₁₀)

Table 7, hereinafter, shows the results (i.e., Code Words) of looking up the 8-bit bytes 0xab and 0xcf in the Main Conversion table:

TABLE 7

| | State 1 | | State 2 | | State 3 | | State 4 | |
|---|---|---|---|---|---|---|---|---|
| | Code Word | | Code Word | | Code Word | | Code Word | |
| 171 | 0010001000001001 | 1 | 0100100000100000 | 3 | 0010001000001001 | 1 | 0100100000100000 | 3 |
| 207 | 0000010010001000 | 2 | 0100001000010001 | 1 | 0000010010001000 | 2 | 0100001000010001 | 1 |

Referring to Table 7, four 16-bit Code Words (corresponding to four different states), each followed by a next state, are provided. Significantly, the next state after state 2 of the 8-bit byte 0xab is 3 and the next state after state 3 for the 8-bit byte 0xcf is state 2. Thus, the sequence of 8-bit bytes 0xab and 0xcf reselects states 3 and 2 repeatedly.

The state 2 Code Word for the 8-bit byte 0xab is 0100100000100000 [t2+, t3, t6, t5+] and the state 3 Code Word for the 8-bit byte 0xcf is 0000010010001000 [t6+, t3, t4, t3+]. When encoded, the foregoing two Code Words will combine as follows:
t3, t6, t11, t3, t4, t5

As can be seen from the combine sequence above, the laser will burn a T11 effect, immediately followed by a T3 rest, immediately followed by burning of a T4 effect. This long burn effect with a short rest period immediately followed by another burn effect causes two artifacts. Firstly, the dye and polymer are overheated in the localized region and the pit definition (i.e., its width) will be sub-optimal, resulting in an incorrect representation of the data and subsequent errors during both reading and writing of the target data stream. Those skilled in the art will recognize that care must be exercised to ensure correct polarity of the laser beam when burning a disc. That is, the laser beam must be active (on) to create the marks (e.g., during the long T11 period). After a short period of laser activation, overexposure will take place due to the laser duty cycle and the T11 mark will “grow” into the following T3 space and eventually yield an artifact that causes instability and erroneous read back.

Use of such a stream will not be problematic when generating a glass master (in order to produce pressed DVD-ROM discs) as these are created using a high quality and high strength laser on a glass substrate, which has much greater precision and much better heat sinking capability compared to a recordable disc. Thus, use of the C3PO technique will not negatively impact an original and legitimate disc. Although a slight DSV accumulation will result, if desired this can be negated in various ways as described in the ECMA-267 Standard. Alternatively, one or more predetermined data sequences can be inserted at targeted locations to generate DSV for canceling the DSV caused by C3PO. Alteration or removal of these predetermined data sequences (e.g., by way of decryption as described hereinbefore) will cause additional errors during data retrieval or playback.

Positioning of the data stream to ensure a known start condition is a requirement for effective use of the C3PO technique, as the logical address information is required for correct scrambling, as well as the state machine which determines the particular code word to be used (columns 1 to 4, as defined in the ECMA-267 Standard) and the state or DC bias of the signal when recorded on the DVD. As EFM+ is a transitional based modulation scheme, a complete inversion of the data stream would yield identical data. However, any DSV or DC content accumulation produced would be inverted. A clear example of this is a T11 mark immediately followed by a T3 space. If the signal state is inverted, the T11 would instead represent a space whereas the T3 would represent a mark. Accordingly, the required polarity of DC bias should be accounted for during the encoding process.

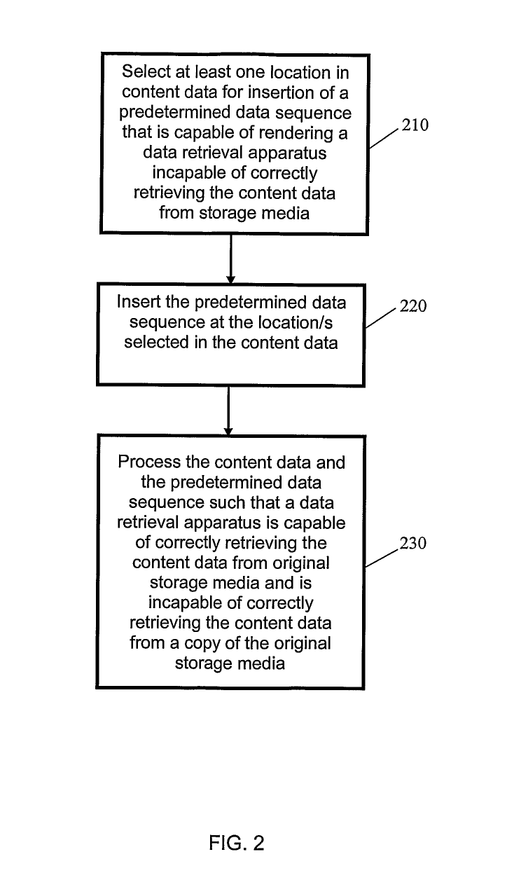

FIG. 2 is a flow diagram of a method for copy protecting content data to be stored on storage media.

At step 210, at least one location in the content data is selected for insertion of a predetermined data sequence. The predetermined data sequence, upon retrieval from storage media by a data retrieval apparatus, is capable of rendering the data retrieval apparatus incapable of correctly retrieving the content data from the storage media.

At step 220, the predetermined data sequence is inserted at the selected location/s in the content data.

At step 230, the content data and predetermined data sequence are processed such that the data retrieval apparatus is capable of correctly retrieving the content data from original storage media the content data is stored on and is incapable of correctly retrieving the content data from a copy of the original storage media.

The processing of step 230 may comprise encryption and/or error control coding of the content data and the predetermined data sequence. Removal of the encryption and/or error control coding from the content data prior to retrieval of the content data from the storage media by a data retrieval apparatus (e.g., during copying) renders the data retrieval apparatus incapable of correctly retrieving the content data from the copied storage media.

In certain embodiments applicable to DVDs, the predetermined data sequence comprises one or more Code Word/s defined in the Main Conversion Table of the ECMA-267 specification repeated a plurality of times. Examples of such predetermined data sequences to generate DSV accumulation, HF noise and/or C3PO have been provided in examples 1 to 7, hereinbefore.

Content Protection based on Encryption

In embodiments of the present invention, the original content data and the additional DSV, HF and/or C3PO generating data are CSS encrypted on an original DVD (i.e., not a pirated copy). The CSS encryption is effectively a form of scrambling that reduces the cumulative effect that results from the unencrypted DSV, HF and/or C3PO generating data being in contiguous locations or locations of close proximity on the DVD. Thus, the effects of the additionally introduced DSV, HF and/or C3PO generating data are not manifested when the data has been CSS encrypted.

However, when pirate copies of DVDs are produced, the CSS encryption is removed. The presence of the unencrypted DSV, HF and/or C3PO generating data causes failure of a commercially available DVD player during retrieval or playback of content data (e.g., loss of servo tracking).

It should be noted that the CSS system typically does not encrypt all the sectors and also does not encrypt all the data in a sector. For example, the first 128 bytes of a sector, which typically comprise “housekeeping” data and MPEG2 headers, are not is encrypted. Accordingly, the additional DSV, HF and/or C3PO generating data should be inserted at locations that will be subjected to CSS (or other) encryption.

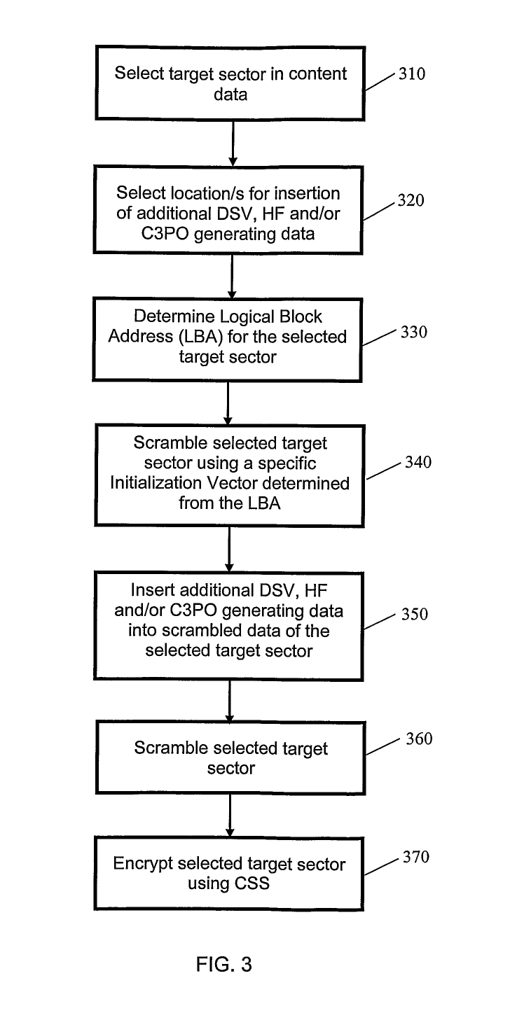

FIG. 3 is a flow diagram of a method for inserting a predetermined data sequence into content data prior to encoding of the content data for creation of a DVD. Encoding of the content data may, for example, be performed using the method described with reference to FIG. 1 and is typically performed by or at a DVD production facility. The method of FIG. 3 is described hereinafter with the predetermined data sequence comprising additional DSV and/or HF generating data, as described hereinbefore. However, other suitable predetermined data sequences may alternatively be used such as C3PO generating data sequences. The method of FIG. 3 assumes that the content data used as input is neither encrypted nor scrambled and comprises sectors of 2,064 bytes (2,048 bytes+12-byte header+4-byte EDC check bits). The method of FIG. 3 may, for example, be performed at a DVD production facility, at a recording studio or by a totally independent party.

Referring to FIG. 3, a target sector in the content data stream is selected for insertion of additional DSV, HF and/or C3PO generating data, at step 310.

At step 320, exact location/s for insertion of the additional DSV and/or HF generating data in the selected target sector are selected. Various methods may be used to select the locations, including packet splitting, free-space utilization or any other suitable method.

At step 330, the sector Logical Block Address (LBA) is determined for the target sector selected in step 310.

At step 340, the selected sector is scrambled using a specific scrambler codec Initialization Vector (IV) determined based on bits 7-4 of the selected sector's LBA.

At step 350, the additional DSV, HF and/or C3PO generating data is inserted into the scrambled selected sector at the locations determined in step 340. Insertion of the additional DSV and/or HF generating data may comprise overwriting data in the target sector.

At step 360, the selected sector comprising scrambled content data and the additional DSV, HF and/or C3PO generating data is again scrambled using the scrambler codec Initialization Vector (IV) determined from bits 7-4 of the LBA. It should be noted that the scrambling process is reversible in that repeated re-scrambling results in alternating manifestations of scrambled and un-scrambled data The output of step 360 thus comprises the original content data in unscrambled form and the additional DSV and/or HF generating data in scrambled form.

At step 370, the selected sector is CSS encrypted using a cryptographic key. A result of the CSS encryption is that the additional DSV, HF and/or C3PO generating data is modified (i.e., the actual data values are changed), thus removing or reducing the effects of the additional DSV, HF and/or C3PO generating data.

When the CS S-encrypted data produced using the method of FIG. 3 or a similar method is encoded at a DVD production facility using the method of FIG. 1 or a similar method, the CSS-encrypted data is scrambled (refer step 130 of FIG. 1). This results in the content data being in scrambled form and the predetermined data sequence being in unscrambled form. When a DVD comprising the encrypted content is played back using a commercially available DVD video player, the undesirable effect of the predetermined data sequence (e.g., additional DSV and/or HF generating data) is not manifested due to descrambling of the content data during playback.

Those skilled in the art will appreciate that the predetermined data sequence can alternatively be inserted into the content data at other stages of the encoding process. For example, a variation of the embodiment described with reference to FIG. 3 may be performed after scrambling of the target sector in the DVD encoding process. In this variation, the predetermined data sequence is inserted directly into the scrambled target sector. It should be noted, however, that scrambling must be performed prior to encryption. A disadvantage of this variation is that changes are required to the encoding process of FIG. 1.

The method described hereinbefore with reference to FIG. 3 may be used to produce legitimate copies of a DVD using encrypted content data. When illegitimate copies are produced, the encryption is removed (i.e., decryption takes place) and the content data is stored on the illegitimate DVD in an unencrypted form. The predetermined data sequence will thus result in excessive levels of DSV, HF and/or C3PO being generated during playback, as described hereinbefore.

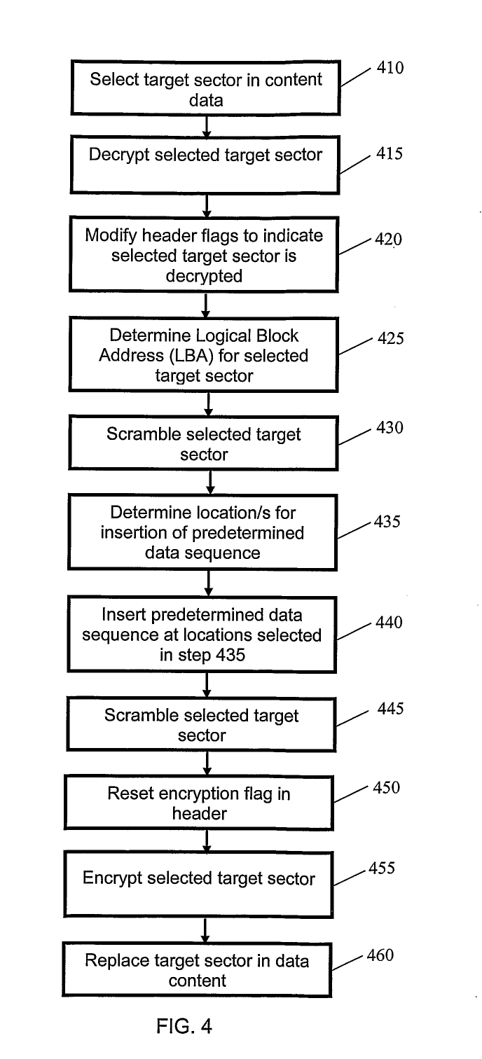

FIG. 4 is a flow diagram of another method for inserting a predetermined data sequence into content data prior to encoding of the content data for creation of a DVD. Encoding of the content data may, for example, be performed using the method described with reference to FIG. 1 and is typically performed by or at a DVD production facility. The method of FIG. 4 is described hereinafter with the predetermined data sequence comprising additional DSV and/or HF generating data, as described hereinbefore. However, other predetermined data sequences may alternatively be used, such as C3PO generating data sequences. The method of FIG. 4 assumes that the content data used as input is CSS encrypted and not scrambled. The method of FIG. 4 may, for example, be performed at a DVD production facility, at a recording studio or by a totally independent party.

Referring to FIG. 4, a target sector in the content data is selected for insertion of a predetermined data sequence, at step 410. The predetermined data sequence comprises additional DSV-generating and/or HF-generating data, as described hereinbefore. Selection of a target sector is subject to certain rules. For example, the selected target sector must be a sector that can be CSS-encrypted. This effectively excludes navigation packets (NAV_PACKS) from being selected as these sectors are not permitted to be CSS encrypted in accordance with the ECMA-267 specification.

At step 415, the content of the target sector selected in step 410 is decrypted using the appropriate CSS key, which may be obtained legitimately or by cryptanalysis. As those skilled in the art would appreciate, the present embodiment may be practiced using an alternative cryptographic system to CSS.

At step 420, the header flags of the selected target sector decrypted in step 415 are modified to indicate that the content of the selected target sector is in the decrypted form.

At step 425 the sector Logical Block Address (LBA) for the selected target sector is determined.

At step 430, the selected target sector is scrambled using a specific scrambler codec Initialization Vector (IV), which is determined based on bits 7-4 of the selected target sector's LBA.

At step 435, location/s for insertion of the predetermined data sequence in the selected target sector is/are selected (e.g., based on available free space or other considerations as described hereinbefore with reference to the method of FIG. 3). In certain embodiments, the predetermined data sequence is preferably located immediately after the SYNC code words to ensure a known start condition. This is in keeping with the ECMA-267 specification, which dictates that a State 1 (column 1) Code Word is always selected, from the Main Conversion Table during EFM+ coding, after the SYNC code words.

At step 440, the predetermined data sequence is inserted in the selected target sector at the locations selected in step 435.

At step 445, the selected target sector including the predetermined data sequence is again scrambled using the scrambler codec Initialization Vector (IV) used in step 430. It should be noted that the scrambling process is reversible in that descrambling and scrambling are equivalent processes. The output of step 445 thus comprises the original content data in unscrambled form and the predetermined data sequence in scrambled form.

At step 450, the encryption flag in the selected target sector header is reset to indicate encryption of the selected sector data content.

At step 455, the selected target sector is CSS encrypted using a cryptographic key. A result of the CSS encryption is that the additional DSV and/or HF generating data is modified (i.e., the actual data values are changed), thus removing or reducing the effects of the additional DSV and/or HF generating data.

At step 460, the original 2,048 byte target sector in the content data is replaced with the target sector that was encrypted in step 455.

When the CS S-encrypted data produced using the method of FIG. 4 or a similar method is encoded at a DVD production facility using the method of FIG. 1 or a similar method, the CSS-encrypted data is scrambled (refer step 130 of FIG. 1). This results in the content data being in scrambled form and the predetermined data sequence being in unscrambled form. When played back using a commercially available DVD video player, the content data is decrypted and the predetermined data sequence is encrypted. Accordingly, the undesirable effect of the predetermined data sequence (e.g., additional DSV and/or HF generating data) is not manifested.

Those skilled in the art will appreciate that the predetermined data sequence can alternatively be inserted into the content data at other stages of the encoding process. For example, a variation of the embodiment described with reference to FIG. 4 may be performed after scrambling of the target sector in the DVD encoding process. In this variation, the predetermined data sequence is inserted directly into the scrambled target sector. It should be noted, however, that scrambling must be performed prior to encryption. A disadvantage of this variation is that changes are required to the encoding process of FIG. 1.

The method described hereinbefore with reference to FIG. 4 may be used to produce legitimate copies of a DVD using encrypted content data. When illegitimate copies are produced, the encryption is removed (i.e., decryption) and the content data is stored on the illegitimate DVD in an unencrypted form. The predetermined data sequence is thus stored on the illegitimate DVD in an unencrypted form and will result in excessive levels of DSV and/or HF being generated during playback, as described hereinbefore.

The methods of FIGS. 2, 3 and 4 described hereinbefore may be applied to any number of target sectors on a DVD or other storage media, as required in particular circumstances.

Content Protection based on Error Correction

In other embodiments, copy protection is achieved through use of the DVD error correction system, as defined in the ECMA-267 specification (using a Reed Solomon Product Code), as opposed to through use of only CSS or another encryption system. An advantage of these embodiments is that they may be applied to sector content that is not subject to CSS encryption (e.g., NAV_PACKS).

Such an embodiment for copy protection through use of the DVD error correction system may comprise the steps of:
inserting a predetermined data sequence into at least one location in a selected target sector in the content data,
generating error control coding information for an error control coding block the target sector is part of, and
providing the error control coding information and the target sector content data without the predetermined data sequence inserted for storage on the DVD.

The error control coding information is generated based on the content data with the predetermined data sequence inserted.

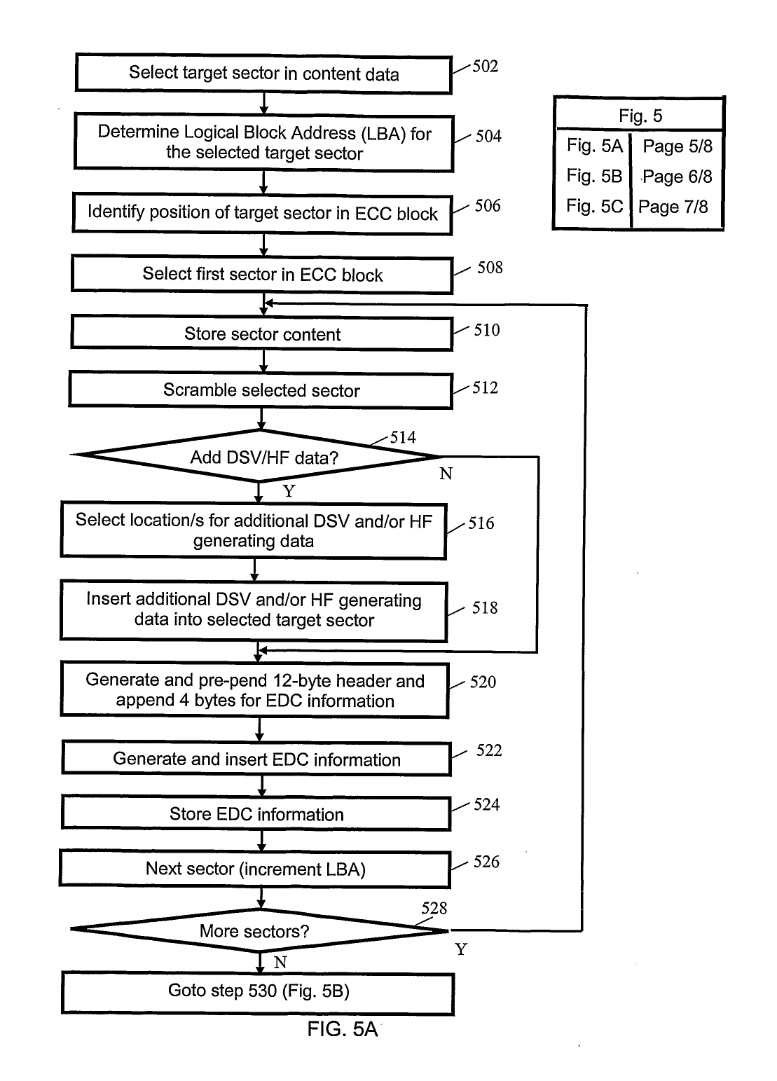

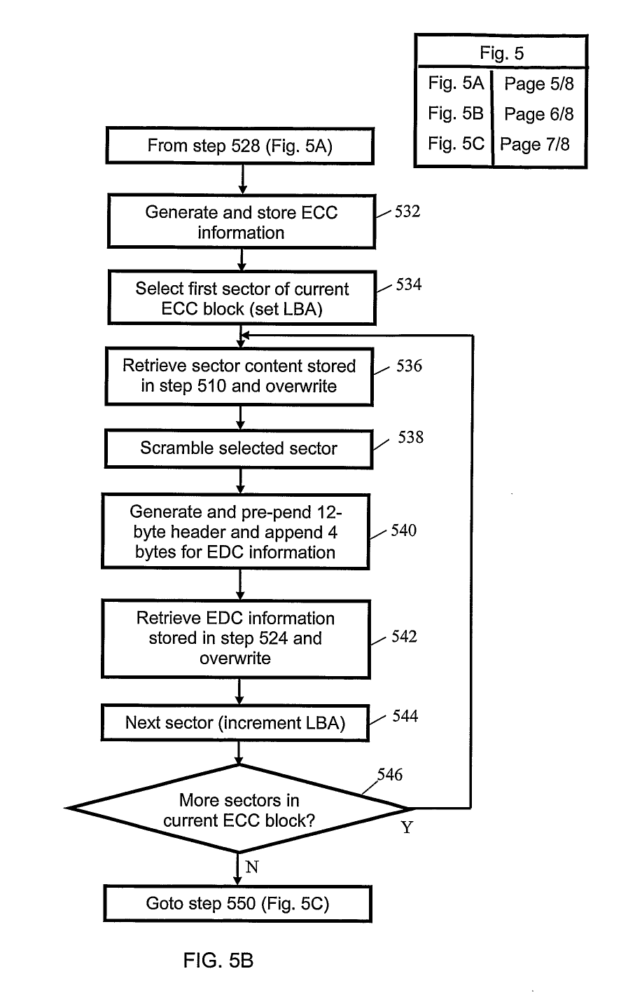

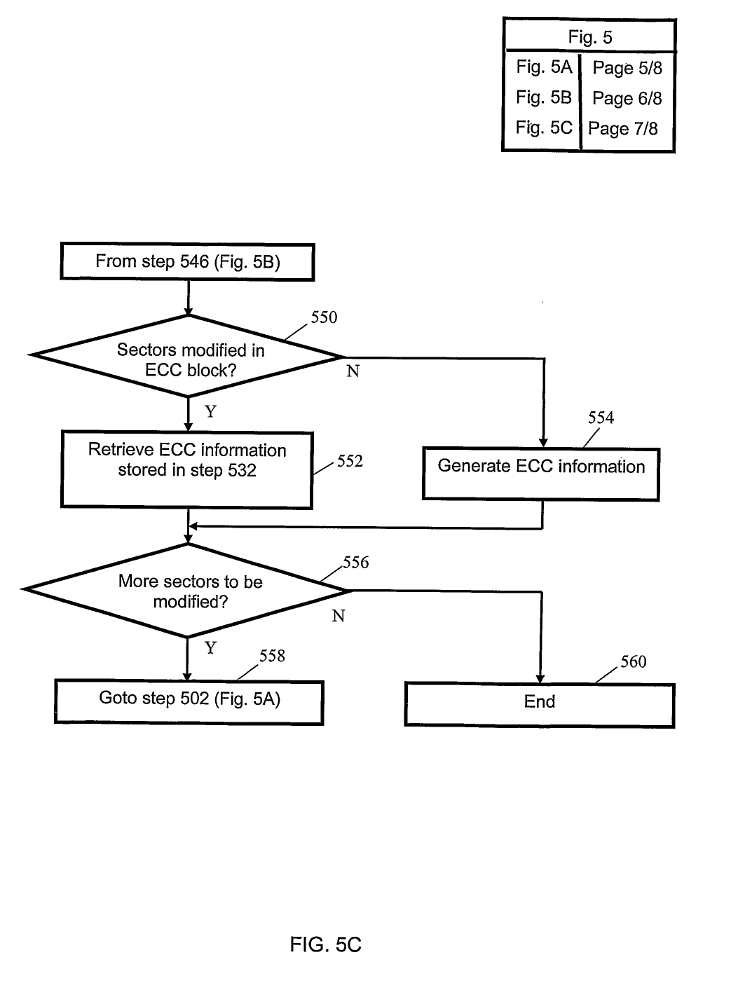

FIG. 5 is a flow diagram of a method for inserting a predetermined data sequence into content data during encoding of the content data for creation of a DVD. The method of FIG. 5 is described hereinafter with the predetermined data sequence comprising additional DSV and/or HF generating data, as described hereinbefore. However, other predetermined data sequences may alternatively be used such as C3PO generating data sequences. The method of FIG. 5 may, for example, be performed at a DVD production facility, at a recording studio or by a totally independent party.

Referring to FIG. 5, a target sector in the content data (byte stream) is selected for insertion of additional DSV and/or HF generating data, at step 502.

At step 504, the Logical Block Address (LBA) is determined for the target sector selected in step 502.

At step 506, the position of the target sector in the ECC block the target sector is part of, is determined.

At step 508, the first sector in the ECC block the target sector is part of, is selected. This ensures that processing of the content data begins at an ECC block boundary, which may be up to a maximum of 15 sectors before the target sector as each ECC block comprises 16 sectors.

At step 510, the content of the selected sector is stored in memory for later to retrieval and use.

At step 512, the selected sector is scrambled using a scrambler codec Initialization Vector (IV) determined based on bits 7-4 of the selected sector's LBA.

At step 514, a determination is made whether additional DV and/or HF generating data is to be inserted into the selected sector (i.e., that the selected sector is a target sector). If so (Y), the exact location/s for insertion of the additional DSV and/or HF generating data in the selected sector are selected, as described in other embodiments hereinbefore, at step 516. Then, at step 518, the additional DSV and/or HF generating data is inserted into the scrambled selected sector at the locations determined in step 516 and processing continues at step 520. If not (N), at step 514, processing proceeds directly to step 520.

At step 520, a 12-byte header is generated and pre-pended and four bytes for Error Detection Code (EDC) information (check bits) are appended to the selected sector. The header comprises an ID field (4 bytes), an IED field that comprises an error detection code covering the ID (2 bytes), and a RESERVED field that contains Copyright Management Information (6 bytes). The RESERVED field is referred to as the CPR_MAI field in certain specifications such as ECMA-267.

At step 522, the EDC information is generated in accordance with the ECMA-267 specification and is inserted into the appropriate locations appended to the selected sector in step 520.

At step 524, the EDC information is stored in memory for later retrieval and use.

At step 526, the next sector in the current ECC block is selected by incrementing the LBA.

At step 528, a determination is made whether there are more sectors in the current ECC block to be processed. If so (Y), the next sector is processed beginning at step 510. If not (N), processing continues at step 532.

At step 532, the Error Control Code (ECC) information is generated for the entire ECC block, as per the ECMA-267 specification, and is stored in memory for later retrieval and use.

At step 534, the LBA is set to point to the start (first sector) of the current ECC block.

At step 536, the original, unmodified sector content stored in step 510 is retrieved.

At step 538, the sector content retrieved in step 536 is scrambled using a scrambler codec Initialization Vector (IV) determined based on bits 7-4 of the selected sector's LBA.

At step 540, a 12-byte header is generated and pre-pended and four bytes for Error Detection Code (EDC) information (check bits) are appended to the currently selected sector. The header comprises an ID field (4 bytes), an IED field that comprises an error detection code covering the ID (2 bytes), and a RESERVED field that contains Copyright Management Information (6 bytes). The RESERVED field is referred to as the CPR_MAI field in certain specifications such as ECMA-267.

At step 542, the EDC information stored in step 524 is retrieved and inserted into the locations appended to the selected sector in step 540. For sectors that include additional DSV and/or HF generating data, the EDC information inserted in this step is representative of the sector content and the additional DSV and/or HF generating data.

At step 544, the next sector in the current ECC block is selected by incrementing the LBA.

At step 546, a determination is made whether there are more sectors in the current ECC block to be processed. If so (Y), the next sector is processed beginning at step 536. If not (N), processing continues at step 550.

At step 550, the LBA is set to point to the first sector of the current ECC block.

At step 552, a determination is made whether additional DSV and/or HF generating data was inserted into the current sector at step 518. If so (Y), the ECC information stored in step 532 is retrieved at step 554 and processing continues at step 558. If not (N), at step 552, the Error Control Code (ECC) information is generated for the entire ECC block, as per the ECMA-267 specification and processing continues at step 558.

At step 558, the next sector is selected by incrementing the LBA.

At step 560, a determination is made whether there are more sectors in the current ECC block to be processed. If so (Y), the next sector is processed beginning at step 552. If not (N), processing may revert to step 502 for selection of another target sector or the process may end.

Steps 502 to 506 of FIG. 5 comprise initial processing relating to selection of a target sector in a current ECC block for insertion of additional DSV and/or HF generating data.

Steps 508 to 532 comprise a first pass through the sectors of the current ECC block, in which additional DSV and/or HF generating data is inserted into one or more selected target sectors. At the end of the first pass, ECC information is generated for the current ECC block based on the original content data and the additional DSV and/or HF generating data, and is stored for later retrieval (step 532).

Steps 534 to 560 comprise a second pass through the sectors of the current ECC block, in which the original unscrambled sector content is retrieved and overwritten as current sector content. After processing of each of the sectors in the current ECC block, ECC information for the current ECC block is either generated or retrieved. The ECC information for the current ECC block is generated if additional DSV and/or HF generating data were not inserted in any of the sectors in the current ECC block. However, if additional DSV and/or HF generating data were inserted in any of the sectors in the current ECC block, the previously stored ECC information, which was generated in the first pass, is retrieved and used.

When a DVD encoded using the method of FIG. 5 is played back using a commercially available DVD video player, undesirable effects caused by additional DSV and/or HF generating data are not manifested. This is because the content data does not include the additional DSV and/or HF generating data and no optical retrieval of the additional DSV and/or HF generating data is thus attempted.

However, when illegitimate copies of a DVD encoded using the method of FIG. 5 are produced, the content data is loaded into memory of the DVD drive and the ECC system uses the ECC information stored on the DVD, which was generated based on the ECC block including the additional DSV and/or HF generating data, to “correct” the content data. Actually, the ECC system “mis-corrects” the content data by inserting the additional DSV and/or HF generating data When the illegitimate copy is played back on a commercially available DVD video player, excessive levels of DSV and/or HF generated during optical reading cause data retrieval or playback failure, as described hereinbefore.

It should be noted that the data changes resulting from addition of a predetermined data sequence in accordance with the method of FIG. 5 are minor in comparison to normal ‘wear-and-tear’ of a disc and are thus well within the error correction capability of the DVD error correction system.

In other embodiments, a further predetermined data sequence corresponding to the additional DSV and/or HF generating data may be inserted at one or more selected locations in the content data during the DVD encoding process to counter the effects of already inserted DSV and/or HF generating data. For example, the further predetermined data sequence may be selected to cause a data stream inversion such that all following pits become lands, and vice versa. This acts to invert the direction of a DSV accumulation, thereby allowing the DSV value to revert back to its starting value, thus effectively nullifying the effects caused by the additional DSV and/or HF generating data. It is imperative that the further predetermined data sequence is inserted after the Error Control Code (ECC) information is generated. This ensures that the further predetermined data sequence is not included in the original PI/PO calculations, effectively rendering it as erroneous noise to be corrected during normal data retrieval or playback.

As the sector content comprises additional DSV and/or HF generating data prior to insertion of the further predetermined data sequence, the ECC data consisting of 302 bytes of PI/PO data (as defined in the ECMA-267 specification) prevents DSV and/or HF accumulation, thus enabling trouble-free playback by a commercially available DVD player. However, once read back into disc drive memory, the error correction system detects the further predetermined data sequence inserted into the content stream and “corrects” it. This effectively removes the further predetermined data sequence from the content stream, thus causing accumulation of DSV and/or HF during playback. Copies are thus corrupted in a similar manner as in other embodiments described hereinbefore.

### Enhanced Content Protection (ECP) Using Error Control Parity Information

Based on the ECMA-267 specification, an ECC block is formed by arranging 16 consecutive Scrambled Frames in an array of 192 rows of 172 bytes each. Sixteen bytes of Parity Outer (PO) Code are added to each of the 172 columns and then 10 bytes of Parity Inner (PI) Code are added to each of the resulting 208 rows. Thereafter, the PI columns and PO rows are interleaved in the columns and rows, respectively. The PI and PO Code symbols are generated by means of a Reed Solomon Product Code (RSPC), which provides error correction capability. A maximum of 5 errors per row and 8 errors per column can be corrected.

In embodiments of the present invention described hereinbefore, one or more predetermined data sequence/s is/are inserted into the original content data prior to, during, or subsequent to encoding of the content data for creation of a DVD, in a controlled fashion. If the Error Control Code (ECC) blocks are generated after insertion of a predetermined data sequence, the predetermined data sequence may be dispersed across more than one row of a particular ECC block) and be interrupted (i.e., broken-up) by the parity information. For example, the PI code bytes may result in multiple reduced run-lengths of the predetermined data sequence and may act to reverse the effect intended to be generated by the inserted predetermined data sequence (e.g., the polarity of the DSV accumulation may be reversed by the PI code bytes). Testing by the present inventor on commercially available DVD drives has indicated that in certain scenarios it can take up to 16 sectors of continuous DSV accumulation to cause sufficient disruption during playback of a DVD protected in accordance with the methods described hereinbefore. This is partly due to the efficiency of the ECC system in correcting errors and partly due to the effects of the PI and/or PO code bytes. The purpose of Enhanced Content Protection (ECP) embodiment is to prevent or at least ameliorate unwanted effects of parity information embedded within a desired predetermined data sequence due to error control coding.

In ECP, the parity code bytes are selected to maintain a run of DSV, HF and/or C3PO by manipulation of their value and/or position in the data that is used to generate the parity code bytes. In the case of PI, any of the 172 bytes of data that precede the 10 bytes of parity may be manipulated in value and/or position to obtain a suitable sequence of parity code bytes. In other words, the position and/or value of to certain bytes in the data that the parity covers is/are manipulated such that the parity bytes contain values that maintain both the DSV, HF and/or C3PO accumulation and the connection rules of EFM+ coding.

As an example (for the case of a DSV generating predetermined data sequence to be inserted in a single row of a selected ECC block), the 172 data bytes of the row may be replaced with the DSV generating value 0x8e. Thereafter, 10 bytes of PI code will be generated and appended to the end of the row. The generated PI code bytes may comprise non-DSV generating bytes or may even comprise values that reverse a DSV accumulation. By an iterative process, various bytes may be selected for replacing the data bytes that are used to generate the parity information for that row. The position of the selected replacement bytes may be altered throughout the row until a suitable sequence of code words results. A suitable sequence in this instance may be a run length of 10 parity bytes or symbols that increase, or at least maintain, the current level of HF, DSV and/or C3PO accumulation.

Enhanced Content Protection (ECP), as described above, will now be described with reference to the encoding process of FIG. 1. A predetermined data sequence (e.g., that will generate DSV, HF and/or C3PO) is inserted at a selected location in a target sector, prior to step 150 of FIG. 1. Then, an ECC block is generated at step 150, which includes generation of the PI and PO code bytes. At new step 155 (not shown in FIG. 1), the relevant row/s and or column/s containing the inserted data sequence is processed. Processing may include replacement, modification and/or repositioning of the data values to maintain as high a DSV, HF and/or C3PO value as possible, as described hereinbefore. The encoding process of FIG. 1 then continues at step 160.

It should be noted that ECP can optionally be expanded to be performed on the columns of an ECC block. This provides the ability to replace PO code bytes so that, in the event of the predetermined data sequence spanning more than one row or sector, interleaved PO columns also do not reverse the desired copy protection effect such as DSV accumulation.

The present inventor has discovered that if ECP is used to ensure that the effect of the predetermined data stream continues unabated, it is possible to cause effective disruptive effects for content protection of a DVD video within a single sector.

The ability to ensure that the disruptive predetermined data sequences continue to through the parity code bytes without disrupting the ECC system provides a significant advantage as this counters a main in-built defense to stop such data streams from causing the problems that they would without such suppression mechanisms. The number of altered data and/or parity bytes in a particular row or column should exceed the error correcting capability for that row or column.

### Download-to-Burn Applications

Embodiments of the present invention advantageously enable digital content to be downloaded (e.g., via a communications network) and transferred (or “burnt”) to conventional DVD recordable media with copy protection that substantially prevents additional “pirate” copies of recorded DVD media being made. That is, the legitimately downloaded content may be transferred to a disk but copying of that disk is substantially prevented. The digital content may comprise, but is not limited to, movies, digital video, games, digital photographs, text, etc.

An apparatus for performing the above may comprise:
a processing unit for executing a computer software application for transcoding digital content into a format suitable for storing on conventional DVD recordable media;
a network interface, coupled to the processing unit, for receiving the digital content via a communications network; and
an optical disk writer, coupled to said processing unit, for transferring said transcoded digital content to conventional DVD recordable media.

The digital content received via the network interface is copy protected in accordance with one or more of the content protection methods described herein.

The processing unit may, for example, comprise one or more microprocessor/s or microcontroller/s with internal or external memory and/or data storage.

The optical disk writer must be capable of transferring digital content copy protected in accordance with one or more of the content protection methods described herein to conventional optically recordable media (e.g., DVDs). The optical disk writer may comprise a conventional, commercially available DVD writer with appropriately modified firmware. For example, the firmware may comprise software program code to decrypt the downloaded digital content. The optical disk writer may further have a unique identification/serial number, which may be used to authenticate a download requesting apparatus. The optical disk writer may further be capable of overwriting, erasing and/or corrupting previously created DVDs.

The apparatus may, for example, comprise a commercially available DVD recorder, a commercially available set-top box, a commercially available gaming machine (e.g., Sony PlayStation or Microsoft Xbox™), a personal computer (PC) with a DVD writer, or a proprietary computer system with an optical disk writer.

The apparatus described above has a number of advantageous applications. For example, consumers may utilize such an apparatus to download and burn movies, games and other digital content to conventional DVD recordable media for playback in a conventional, commercially available DVD player or gaming machine.

A further advantageous application is the production of DVDs to order from a virtual inventory of digital content. Production of the DVDs may be performed at a mass production facility or at a computer system or kiosk located in a store or public location.

### Computer Hardware and Software

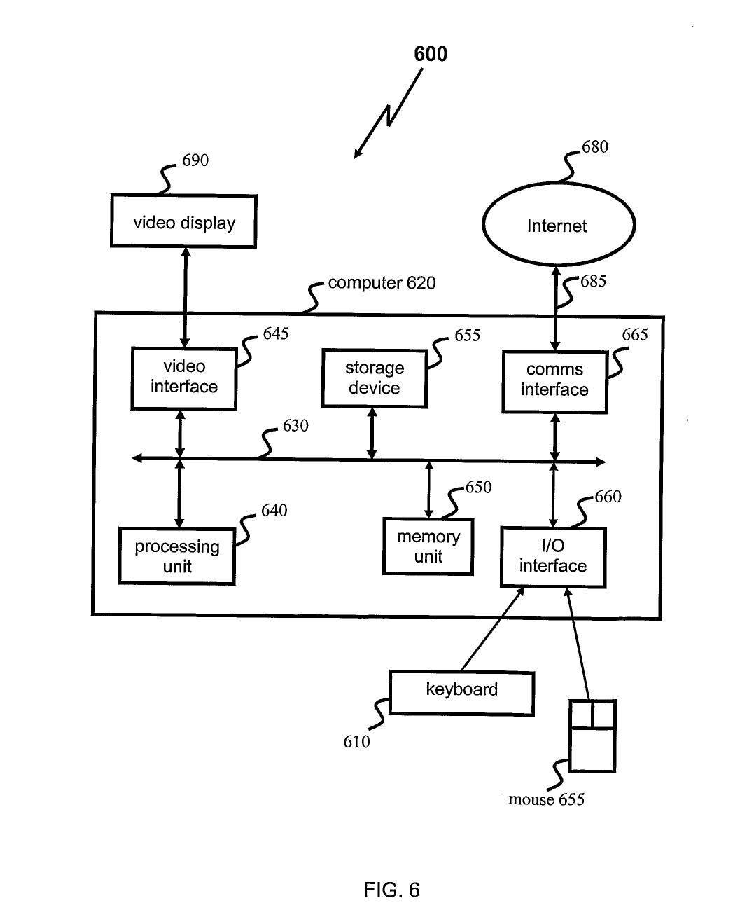

FIG. 6 shows a schematic block diagram of a computer system 600 that can be used to practice the methods described herein. More specifically, the computer system 600 may be used to execute computer software that is programmed to assist in performing a method for copy protecting content data to be stored on storage media. The computer software executes under an operating system such as MS Windows 2000, MS Windows XP™ or Linux™ installed on the computer system 600.

The computer software involves a set of programmed logic instructions that may be executed by the computer system 600 for instructing the computer system 600 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 600 comprise: a computer 620, input devices 610, 615 and a video display 690. The computer 620 comprises: a processing unit 640, a memory unit 650, an input/output (I/O) interface 660, a communications interface 665, a video interface 645, and a storage device 655. The computer 620 may comprise more than one of any of the foregoing units, interfaces, and devices.

The processing unit 640 may comprise one or more processors that execute the operating system and the computer software executing under the operating system. The memory unit 650 may comprise random access memory (RAM), read-only memory (ROM), flash memory and/or any other type of memory known in the art for use under direction of the processing unit 640.

The video interface 645 is connected to the video display 690 and provides video signals for display on the video display 690. User input to operate the computer 620 is provided via the input devices 610 and 615, comprising a keyboard and a mouse, respectively. The storage device 655 may comprise a disk drive or any other suitable non-volatile storage medium.

Each of the components of the computer 620 is connected to a bus 630 that comprises data, address, and control buses, to allow the components to communicate with each other via the bus 630.

The computer system 600 may be connected to one or more other similar computers via the communications interface 665 using a communication channel 685 to a network 680, represented as the Internet.

The computer software program may be provided as a computer program product, and recorded on a portable storage medium. In this case, the computer software program is accessible by the computer system 600 from the storage device 655. Alternatively, the computer software may be accessible directly from the network 680 by the computer 620. In either case, a user can interact with the computer system 600 using the keyboard 610 and mouse 615 to operate the programmed computer software executing on the computer 620.

The computer system 600 may also be used to perform download-to-burn applications, as described hereinbefore. In this instance, the storage device 655 may comprise an optical disk writer. Alternatively, an optical disk writer (not shown) may be coupled to the computer system 600.

The computer system 600 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practice the methods and computer program products described hereinbefore.

### CONCLUSION

A small number of embodiments of methods, systems and computer program products have been described hereinbefore for digital content protection or for copy protection of content data to be stored on storage media.

Advantageously, certain embodiments of the present invention (e.g., the embodiments that use CSS or other encryption) do not require modification to the equipment used at pressing plants to produce DVDs. More specifically, modifications are not required to the glass mastering equipment, the verification equipment and the encoding equipment at a pressing plant. Thus, certain embodiments of the present invention may be performed totally independently of, and transparently to, a DVD production facility. DVDs may thus be mastered and pressed at any facility irrespective of the hardware used at a particular facility. Complexities commonly associated with conventional content security mechanisms such as transfer of cryptographic keys, special signatures and bypassing of verification equipment are thus avoided.

Advantageously, embodiments of the present invention do not introduce DVD compatibility problems as no change is required to be made to the physical structure to of the physical media (i.e., disks).

Embodiments of the present invention advantageously enable fair use of the protected content. That is, the copy protection does not degrade playback quality when the content is transcoded to a Sony PSP™ or an Apple iPod™ or to an alternative format. Playback degradation will, however, occur when the content is decrypted and burnt or pressed to an optical disc with the encryption removed or when the content is error control coded during copying.

Insertion of a predefined data sequence in the content data may generally be performed at various stages of the DVD encoding process. However, the degree of complexity generally increases when the insertion is performed earlier in the encoding process (i.e., at a lower level).

Embodiments described hereinbefore refer to a predetermined data sequence. It should be understood that such a predetermined data sequence may comprise a single byte or multiple bytes of data. Furthermore, multiple predetermined data sequences may be practiced, which may be inserted into content data at various different locations in the content data.

The amount of DSV, HF or localized heating (C3PO) generated by embodiments of the present invention may be controlled in accordance with particular requirements or circumstances. More specifically, the location/s at which the predetermined data sequences are inserted into the content data may be carefully selected. For example, a content owner or studio may specify that playback degradation of a pirate copy of a movie first occur, say, 15 minutes and/or at other random time intervals and durations after the start of a movie, thus resulting in wasted time and products when copied.

The predetermined data sequences may inserted at any point in the content. Post processing software may be employed to determine all possible or convenient positions for insertion of the predetermined data sequences in the content. Alternatively, data packets (sectors) may be broken to artificially create a specific point of insertion. For example, it may be desirable that a specific sequence such as a high profile scene in a movie be copy protected. Playback degradation at such a point will obviously be undesirable to viewers.

The foregoing description provides exemplary embodiments only, and is not intended to limit the scope, applicability or configurations of the present invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

The term “comprising” as used in the context of the present specification is intended to have the open-ended non-exclusive meaning of “including principally, but not necessarily solely” and not the meaning of “consisting essentially of” or “consisting solely of”. Grammatical variations of the term “comprising”, such as “comprise, “comprises” and “is comprised of”, are intended to have corresponding meanings.

1. A method for copy protecting content data to be stored on optical storage media, said method comprising the steps of:
selecting at least one location in said content data for insertion of a predetermined data sequence, which upon retrieval from said storage media by a data retrieval apparatus, is capable of rendering said data retrieval apparatus incapable of correctly retrieving said content data from said storage media;
inserting said predetermined data sequence at said at least one selected location in said content data; and
processing said content data and said predetermined data sequence such that said data retrieval apparatus is capable of correctly retrieving said content data from original storage media said content data is stored on and is incapable of correctly retrieving said content data from a copy of said original storage media.

2-3. (canceled)

4. A method according to claim 1, wherein said processing step comprises encrypting said content data and said predetermined data sequence.

5. A method according to claim 1, wherein said processing step comprises scrambling said content data and said predetermined data sequence.

6. A method according to claim 1, wherein said processing step comprises the step of generating error control code information for said content data and said predetermined data sequence such that when said content data and said predetermined data sequence are subjected to error correction using said error control code information, the data values of said predetermined data sequence are changed, and
wherein said error control information is generated based on said content data without said predetermined data sequence inserted.

7-10. (canceled)

11. A method according to claim 1, wherein retrieval of said predetermined data sequence by said data retrieval apparatus results in a level of Digital Sum Value (DSV) noise that causes incorrect data retrieval by said data retrieval apparatus.

12. A method according to claim 5, wherein said predetermined data sequence comprises a Content Word that corresponds to the data sequence 0x95 in the Main Conversion Table of the ECMA-267 specification.

13. A method according to claim 5, wherein said predetermined data sequence comprises Content Words from the Main Conversion Table of the ECMA-267 specification that correspond to one of the data sequences in the list of data sequences consisting of:
0xc5 and 0x5c;
0x89 and 0x95;
0x8e and 0x9e; and
0x95 and 0x9e.

14. A method according to claim 1, wherein said predetermined data sequence results in a level of High Frequency (HF) noise that causes incorrect data retrieval by said data retrieval apparatus.

15. A method according to claim 8, wherein said predetermined data sequence comprises a Content Word that corresponds to the data sequence 0x62 in the Main Conversion Table of the ECMA-267 specification.

16. A method for copy protecting encrypted content data to be stored on a DVD, said method comprising the steps of:
selecting a target sector in said encrypted content data;
decrypting said target sector;
determining a Logical Block Address for said selected target sector;
scrambling said target sector using an Initialization Vector derived based on said Logical Block Address;
selecting at least one location in said content data for insertion of a predetermined data sequence which is capable of rendering a data retrieval apparatus incapable of correctly retrieving said content data from said DVD;
inserting said predetermined data sequence into said at least one location;
scrambling said target sector; and
encrypting said target sector.

17. (canceled)

18. A method for copy protecting content data to be stored on a DVD, said method comprising the steps of:
inserting a predetermined data sequence into at least one location in a selected target sector in said content data;
generating error control coding information for an error control coding block said target sector is part of, wherein said error control coding information is generated based on said content data with said predetermined data sequence inserted; and
providing said error control coding information and said target sector content data without said predetermined data sequence inserted for storage on said DVD.

19. (canceled)

20. A computer system for copy protecting content data to be stored on optical storage media, said computer system comprising:
a memory unit for storing data and instructions to be performed by a processing unit; and
a processing unit coupled to said memory unit, said processing unit programmed to:
select at least one location in said content data for insertion of a predetermined data sequence, which upon retrieval from said storage media by a data retrieval apparatus, is capable of rendering said data retrieval apparatus incapable of correctly retrieving said content data from said storage media;
insert said predetermined data sequence at said at least one selected location in said content data; and
process said content data and said predetermined data sequence such that said data retrieval apparatus is capable of correctly retrieving said content data from original storage media said content data is stored on and is incapable of correctly retrieving said content data from a copy of said original storage media.

21-38. (canceled)

39. A computer program product comprising a computer readable medium comprising a computer program recorded therein for copy protecting content data to be stored on optical storage media, said computer program product comprising:
computer program code means for selecting at least one location in said content data for insertion of a predetermined data sequence, which upon retrieval from said storage media by a data retrieval apparatus, is capable of rendering said data retrieval apparatus incapable of correctly retrieving said content data from said storage media;
computer program code means for inserting said predetermined data sequence at said at least one selected location in said content data; and
computer program code means for processing said content data and said predetermined data sequence such that said data retrieval apparatus is capable of correctly retrieving said content data from original storage media said content data is stored on and is incapable of correctly retrieving said content data from a copy of said original storage media.

40-57. (canceled)

58. A method according to claim 1, wherein said predetermined data sequence results in localized heating of said optical disk that causes incorrect data retrieval by said data retrieval apparatus.

59. A method according to claim 14, wherein said predetermined data sequence comprises a Content Word that corresponds to the data sequence 0xabcf in the Main Conversion Table of the ECMA-267 specification.

60-63. (canceled)

64. A method according to claim 1, comprising the further step of modifying one or more data bytes used to subsequently generate error control parity code bytes such that said parity code bytes comprise values that maintain the effect caused by said predetermined data sequence of rendering said data retrieval apparatus incapable of correctly retrieving said content data from a copy of said original storage media.

65-70. (canceled)

71. A method according to claim 1 further comprising providing an apparatus, comprising:
a processing unit for executing a computer software application for transcoding digital content into a format suitable for storing on conventional DVD recordable media;
a network interface, coupled to said processing unit, for receiving said digital content via a communications network; and
an optical disk writer, coupled to said processing unit, for transferring said transcoded digital content to conventional DVD recordable media;
said apparatus for copy protecting said digital content received via said network interface.

72. A method according to claim 16 further comprising providing an apparatus, comprising:
a processing unit for executing a computer software application for transcoding digital content into a format suitable for storing on conventional DVD recordable media;
a network interface, coupled to said processing unit, for receiving said digital content via a communications network; and
an optical disk writer, coupled to said processing unit, for transferring said transcoded digital content to conventional DVD recordable media;
said apparatus for copy protecting said digital content received via said network interface.

73. A method according to claim 18 further comprising providing an apparatus, comprising:
a processing unit for executing a computer software application for transcoding digital content into a format suitable for storing on conventional DVD recordable media;
a network interface, coupled to said processing unit, for receiving said digital content via a communications network; and
an optical disk writer, coupled to said processing unit, for transferring said transcoded digital content to conventional DVD recordable media;
said apparatus for copy protecting said digital content received via said network interface.
